(19) United States
(12) Patent Application Publication
(10) Pub. No.: US 2006/0200664 A1
(43) Pub. Date: Sep. 7, 2006

(54) System and method for securing information accessible using a plurality of software applications

(76) Inventors: Dave Whitehead, Glossop (GB); Paul T. Pullinger, Cobham (GB)

Correspondence Address: BAKER BOTTS L.L.P., 2001 ROSS AVENUE, 6TH FLOOR, DALLAS, TX, 75201, US

(21) Appl. No.: 11/073,899

(22) Filed: Mar. 7, 2005

(51) Int. Cl. H04L 9/00

(52) U.S. Cl. 713/165

(57) ABSTRACT

A system for securing information accessible using a plurality of software applications includes a computer readable storage medium and computer software stored on the computer readable storage medium. The computer software may receive a request from a user to process information using one of a plurality of software applications and may retrieve user information associated with the user. The computer software may determine whether the user has authority to process the information as requested according to the retrieved user information and one or more rules defined using XACML. The computer software may allow the user to process the information using the software application in response to determining that the user has authority to process the information as requested and may prevent the user from processing the information using the software application in response to determining that the user does not have authority to process the information as requested.

### TECHNICAL FIELD OF THE INVENTION

This invention relates to the field of computer security and, more specifically, to a system and method for securing information accessible using a plurality of software applications.

### BACKGROUND OF THE INVENTION

Enterprises use data networks to store information that may be accessed and processed by users. Typically, data networks store information that may be used by a number of software applications. Some software applications include security features that limit the individuals who may access or process information; however these features are often not detailed or fine grained enough or rigorously enforced to ensure correct access control to the information. Additionally, software applications do not provide a homogeneous approach to security enforcement and thus present substantial system management challenges. As the number or users and number of applications have increased, it has become more difficult to secure the information stored across a computer network.

### SUMMARY OF THE INVENTION

In accordance with the invention, a system and method for securing information accessible using a plurality of software applications is provided that substantially eliminates or reduces disadvantages or problems associated with previously developed systems and methods.

In one embodiment, a system for securing information accessible using a plurality of software applications includes a computer readable storage medium and computer software stored on the computer readable storage medium. The computer software may receive a request from a user to process information using one of a plurality of software applications and may retrieve user information associated with the user. The computer software may determine whether the user has authority to process the information as requested according to the retrieved user information and one or more rules defined using XACML. The computer software may allow the user to process the information using the software application in response to determining that the user has authority to process the information as requested and may prevent the user from processing the information using the software application in response to determining that the user does not have authority to process the information as requested.

The invention provides a number of important technical advantages. Using the present invention, an enterprise may efficiently integrate commercially available software into the enterprise's existing security structure. As a result, the enterprise may take advantage of the economies of scale that accrue from using commercial, off-the-shelf (COTS) software. Furthermore, the invention uses the software's application programming interface (API) and abstracts the mechanism for ingesting and extracting information from the software package. As a result, an enterprise may define its security rules without having to adjust or update the rules each time a specific COTS application is added to system or modified. Embodiments of the invention may have none, some, or all of these advantages without departing from the scope of the invention.

### BRIEF DESCRIPTION OF THE DRAWINGS

For a more complete understanding of the present invention and the advantages thereof, reference is now made to the following descriptions taken in conjunction with the accompanying drawings in which:

FIG. 1 is a block diagram of a general purpose computer that may be used to secure information accessible using a plurality of software applications;

FIG. 2 is a block diagram of one embodiment of a system for securing information accessible using a plurality of software applications;

FIG. 3 illustrates a block diagram of a particular embodiment of a security enforcement layer; and

FIG. 4 illustrates a flowchart of a particular embodiment of a method of securing information accessible using a plurality of software applications.

### DETAILED DESCRIPTION OF THE DRAWINGS

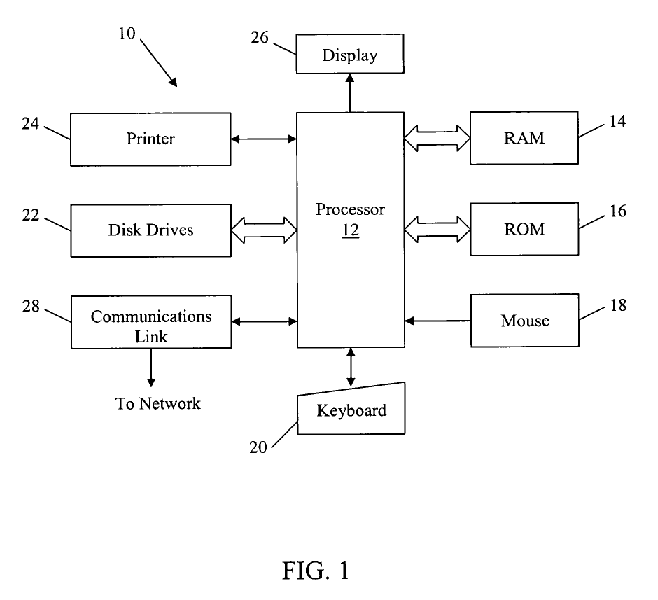

The preferred embodiment of the present invention and its advantages are best understood by referring to FIGS. 1 through 4 of the drawings, like numerals being used for like and corresponding parts of the various drawings.

FIG. 1 illustrates a block diagram of a general purpose computer 10 that may be used for analyzing information relating to network devices. General purpose computer 10 may be adapted to execute any of the well known MS-DOS, PC-DOS, OS2, UNIX, MAC-OS and Windows operating systems or other operating systems. As used in this document, operating system may refer to the local operating system for computer 10, a network operating system, or a combination of both. General purpose computer 10 comprises processor 12, random access memory (RAM) 14, read only memory (ROM) 16, mouse 18, keyboard 20, and input/output devices such as printer 24, disk drives 22, display 26 and communications link 28. The present invention includes programs that may be stored in RAM 14, ROM 16, or disk drives 22 and may be executed by processor 12. Communications link 28 is connected to a computer network but could be connected to a telephone line, an antenna, a gateway, or any other type of communication link. Disk drives 22 may include a variety of types of storage media such as, for example, floppy disk drives, hard disk drives, CD ROM drives, DVD-ROM drives, or magnetic tape drives. Disk drive 22 may also include a network disk housed in a server within the enterprise network. Software for the invention may be stored on one or more storage media located on one or more computers. Although this embodiment employs a plurality of disk drives 22, a single disk drive 22 could be used without departing from the scope of the invention. FIG. 1 only provides one example of a computer that may be used with the invention. The invention could be used with computers other than general purpose computers as well as general purpose computers without conventional operating systems.

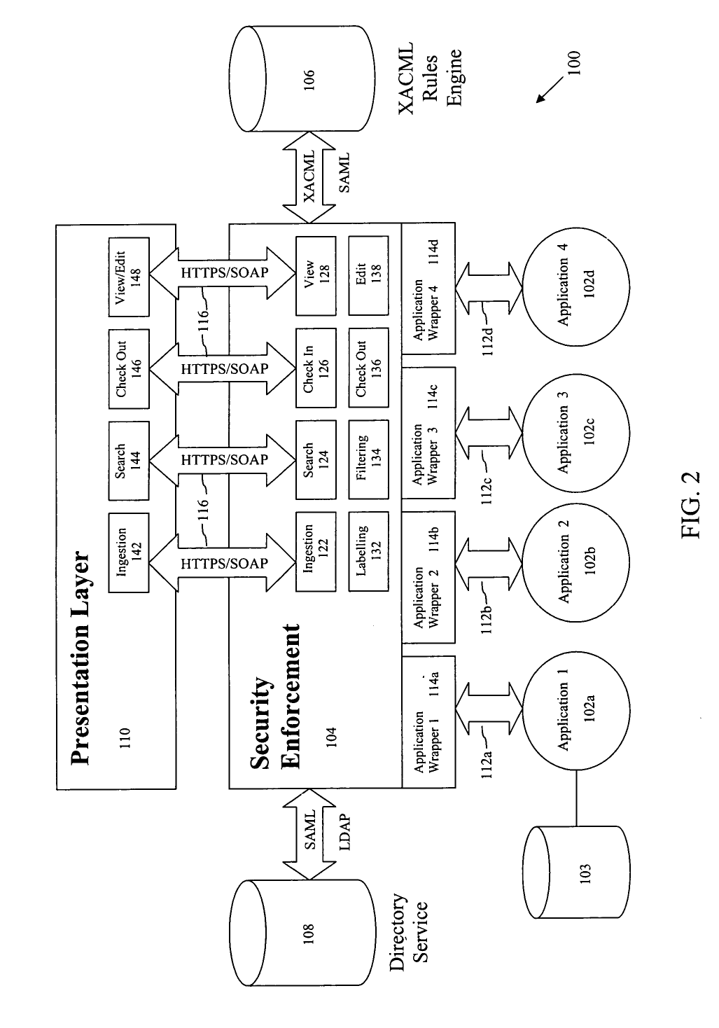

FIG. 2 illustrates a block diagram of one embodiment of a system 100 for securing information accessible using a plurality of software application 102a, 102b, 102c, and 102d (collectively, software applications 102). System 100 includes a security enforcement layer (SEL) 104, an XACML (eXtensible Access Control Markup Language) rules engine 106, a directory service 108, and a presentation layer 110.

In the illustrated embodiment, software applications 102 are commercial, off-the-shelf (COTS) applications. COTS is a term for software applications that are manufactured for sale to many customers, who may or may not tailor the software for their specific uses. COTS applications are in contrast to other software that is produced entirely and uniquely for a single customer's specific use. In alternative embodiments, software applications 102 may include non-COTS applications, such as software that is produced entirely and uniquely for a single customer's specific use. Software applications 102 interact with SEL 104 using their application programming interfaces 112a, 112b, 112c, and 112d (collectively, application programming interfaces 112). In a particular embodiment, when a software application 102 is added or modified, only the application wrappers 114a, 114b, 114c, and 114d (collectively application wrappers 114) have to be modified, and as a result, the remaining functionality of SEL 104, rules engine 106, and directory service 108 may remain the same.

SEL 104 serves as a mediator between users and information associated with applications 102. SEL 104 receives users' service requests from presentation layer 100 and enforces the rules defined in rules engine 106 to control users' access and processing of information using software applications 102. SEL 104 may use any type of metadata, security label attributes, and user attributes to execute the security rules defined in rules engine 106. SEL 104 includes application wrappers 114 which interface with applications 102 using APIs 112. Using application wrappers 114, SEL 104 may ingest and extract information from software applications 102. SEL 104 consistently applies the security rule in rules engine 106 across all applications 102 and data sources 103 associated with applications 102. In a particular embodiment, SEL 104 generates audit events for every action that SEL 104 performs on a user's behalf.

In a particular embodiment, SEL 104 includes modules which perform a set of related operations. For example, in the illustrated embodiment, SEL 104 includes an ingestion module 122, a search module 124, a check-in module 126, a view module 128, a labeling module 132, a filtering module 134, a check-out module 136, and an edit module 138.

Ingestion module 122 and labeling module 132 receive documents, files, or other objects to be stored in system 100. Ingestion module 142 receives an object and associated attributes and security information from a user through ingestion module 142 of presentation layer 110. Ingestion module 122 may prompt users for particular attributes or security information. For example, in a particular embodiment, all documents and other objects in system 100 may be associated with a security clearance level, and ingestion module 122 may prompt users to provide a value for the security clearance level associated with each document or other object to be ingested into system 100. In a particular embodiment, ingestion module 122 may not receive an existing document or object, but instead, it may receive attributes and security information to associated with a new object to be created by one of applications 102.

Labeling module 132 generates a security label to be associated with each document or other object ingested into system 100. The security label may include user information, attributes, security information, and/or metadata to be associated with the document or object. For example, a document stored in system 100 may be associated with one or more users, geographic locations, organizational departments, or sensitivity clearance levels. Labeling module 132 may receive the attributes or security information provided to ingestion module 122 and generate a security label associating those attributes and security information with the object. In a particular embodiment, a security label may include user information relating to the user who initially ingested the document or other object into system 100, or the security label may include user information relating to any user who accesses or edits the document or other object. In another particular embodiment, labeling module 132 may receive or generate metadata that may be included in the security label of a document or other object. Object security labels may be held as digitally signed XML.

Search module 124 and filtering module 134 receive a search request and search criteria from a user and then present a list of objects that meet the user's search criteria. Search module 124 receives the search request and search criteria through search module 144 of presentation layer 110. Search module 144 searches a database or other memory 103 for documents or other stored objects according to the received search criteria. Search module 124 interacts with one or more applications 102 using associated application wrappers 114.

Filtering module 134 restricts users' access to documents according to the security rules defined in rules engine 106. In a particular embodiment, filtering module 134 ensures that, of the set of documents or other objects that meet a user's search criteria according to search module 124, only those objects that the user may access according the security rules may be identified in response to the user's search request. To determine whether a user may access an object, filtering module 134 applies the security rules defined in rules engine 106 using user attributes and/or information from the security label associated with the objects.

Check-in module 126 and check-out module 136 allow users to work with documents and other objects outside of system 100 and to return the documents or objects to system 100. This functionality may prevent other users from modifying an object while it is checked-out of system 100. Check-out module 136 receives a request to check-out an object from a user through check-out module 146 of presentation layer 110. In a particular embodiment, a user may select an object from a list generated by search module 124. Check-out module 136 allows a user to check-out only objects that the user may check-out according to the security rules defined in rules engine 106. To determine whether a user may check-out an object, check-out module 136 applies the security rules defined in rules engine 106 using user attributes and/or information from the security label associated with the object. If SEL 104 determines that the user may check-out the identified object, check-out module 146 completes the check-out procedure.

Check-in module 126 allows a user to return a checked-out to system 100. In a particular embodiment, check-in module 126 presents a user with a list of objects that the user has checked out from system 100, and the user may select one or more of the objects to check-in to SEL 104.

View module 128 receives a request to view a document or other object stored in system 100 and presents the object in response to the request. View module 128 receives a request to view an object from a user through view/edit module 148 of presentation layer 110. In a particular embodiment, a user may select an object from a list generated by search module 124. View module 128 may receive an identifier identifying the object with the view request or may prompt the user for information that identifies the object. View module 128 allows a user to view only objects that the user may view according to the security rules defined in rules engine 106. To determine whether a user may view an object, view module 128 applies the security rules defined in rules engine 106 using user attributes and/or information from the security label associated with the object.

Edit module 138 receives a request to edit a document or other object stored in system 100 and enable a user to edit the object. Edit module 138 receives a request to edit an object from a user through view/edit module 148 of presentation layer 110. Edit module 138 may receive an identifier identifying the object with the edit request or may prompt the user for information that identifies the object. In a particular embodiment, a user may select an object from a list generated by search module 124. Edit module 138 allows a user to edit only objects that the user may edit according to the security rules defined in rules engine 106. To determine whether a user may edit an object, edit module 138 applies the security rules defined in rules engine 106 using user attributes and/or information from the security label associated with the object.

Rules engine 106 defines the rules for access control and secure information mediation using extensible Access Control Markup Language (XACML) configuration files. Rules engine 106 may use any type of metadata, security label attributes, and user attributes to define the security rules. For example, a rule may provide that a user may access an object only if the user's clearance level is greater than or equal to the clearance level associated with the object. Some rules may include more than one requirement. For example, a rule may provide that a user may access an object only if (a) the user's clearance level is greater than or equal to the clearance level associated with the object and (b) the user's geographic location matches one or more geographic locations associated with the object. There is no limit on the attributes that may be used to build up rule sets. An administrator may change the security labels in the XACML rules. In a particular embodiment, these files may be digitally signed to prevent unauthorized alteration to the security rules. Because rules engine 106 uses the rules to define the security requirements, the rules may be changed to implement new security requirements without changing the computer software of SEL 104.

Directory service 108 authenticates users and establishes a user session with SEL 104. In a particular embodiment, directory service 108 uses a strong form of identification and authorization, such as PKI and smart cards.

Directory service 108 also stores user attributes, which may include a user's security clearance level, special access options, and physical or geographic location. SEL 104 may use these user attributes to restrict information that each user may view and to ensure that a user is not even aware of the existence of a document to which the user does not have access privileges. An administrator may change a user's attributes stored in directory service 108. Some user attributes may be optional; others may be mandatory. In a particular embodiment, some user attributes may be hidden such that only a limited group of individuals have controlled access to the attributes. Examples of user attributes include unique user ID, name, location details, nationality, contact information, organizational hierarchy (subordinates, superiors), and sensitivity clearance (maximum level of sensitivity allowed). In a particular embodiment, the user may be associated with an access group, which is a group of individuals who are given access to one or more objects stored in system 100. User security labels are passed to SEL 104 as digitally signed SAML (Security Assertion Markup Language) assertions on web services.

Presentation layer 110 presents users of system 100 with a set of processes to manage data within system 100. Presentation layer 110 provides a user-navigable interface and generates the necessary requests to SEL 104 according to users' input. Presentation layer 110 may also interact with a user's private file store. In the particular embodiment illustrated in FIG. 2, presentation layer 110 uses the web to interact with users using HTTPS (HyperText Transfer Protocol, Secure). Because SEL 104 acts as a mediator between the users and applications 102, this security mediation process with the users may remain consistent, irrespective of the underlying applications 102. If one of applications 102 is changed, one may adapt to the change by altering associated application wrapper 114. In a particular embodiment, users interact with SEL 104 through a set of web services accessed via Simple Object Access Protocol (SOAP) using a secure HTTP connection 116.

In a particular embodiment, presentation layer 110 includes modules with which users may interact to perform specific operations. For example, in the illustrated embodiment, web presentation layer 110 includes an ingestion module 142, a search module 144, a check-out module 146, and a view/edit module 148. Various embodiments may include more or less modules and the function performed by each module may be combined, separated, or omitted.

Users interact with ingestion module 142 to ingest a document, file, or other object in system 100. Ingestion module 142 receives the object and associated attributes and security information from a user and communicates the object and the associated attribute and security information to SEL 104.

Users interact with search module 144 to search a database or other memory 103 for documents or other stored objects. Search module 144 receives a search request and search criteria from a user and communicates the search request and search criteria to SEL 104.

Users interact with check-out module 146 to check-out a document, file, or other object from system 100. Check-out module 146 receives information identifying the object and communicates the identification information to SEL 104. If SEL 104 determines that the user may check-out the identified object, check-out module 146 completes the check-out procedure.

Users interact with view/edit module 148 when they want to view or edit a document, file, or other object in system 100. View/edit module 148 receives information identifying the object and communicates the identification information to SEL 104. If SEL 104 determines that the user may view and/or edit the identified object, view/edit module 148 enables the user to view and/or edit the object.

In operation, directory service 108 authenticates a user and establishes a stateless session. Each user's active session is assigned a security label that is passed into the SEL 104 as a signed SAML assertion on every request. The labels identify the users for audit purposes and associate them with security attributes for this location and their business role.

Documents or other objects stored in system 100 have a signed security label that comprises a customer label, metadata for the item, and a reference to the content. The customer label for an object may include a distribution list/access list for the object. A digital signature protects a hash for the content, and a hash for the label and metadata, so that any unauthorized alteration of the object can be detected. This signature must be checked before a user can view the item.

SEL 104 uses a set of policies, defined in signed XACML in rules engine 106, to indicate whether any given user has the permission to undertake any given operation on an object within system 100. An policy defines a set of rules that apply to a given set of targets. A target is defined as a set of attribute values from the label for either the user attempting the operation or the object that the user is attempting to access. A rule mayt define a set of conditions that evaluate to either “Permit” or “Deny.” These conditions may include qualitative evaluation of the attribute values from the targets. If a rule's effect is to “Deny” permission then the policy prevents the execution of the operation regardless of whether any other rules have a “Permit” effect. If a rule encounters an error then the effect is taken as a “Deny.” SEL 104 must evaluate all rules until either a “Deny” is found which prevents execution or all of the rules have been evaluated to “Permit” execution.

When a user requests system 100 to ingest an object of content, SEL 104 may request the user to specify the metadata and security label associated with that object, determined by the currently defined schema for security label and metadata. Metadata generally comprises document details, security clearances required to access the document, taxonomy placement, summary keywords, and other restrictions. Some of these field may be mandatory in some embodiments. The precise schema for labeling and metadata can be configured on an implementation by implementation basis. In a particular embodiment, system 100 will assist the user by providing default entries for as many metadata attributes as possible based on document information and lexical analysis of the document, and the user can choose to accept those values, change, or augment them.

When a user requests system 100 to view or edit an object of content, the users may search or browse the database or other repository of objects. SEL 104 performs these actions against software applications 102 on the user's behalf, ensuring that result sets from software applications 102 are filtered against the user's security credentials prior to displaying any result to the user. When the user subsequently selects a specific item to view or edit, SEL 104 may once again validate the user's access privileges to that item. SEL 104 carries out a number of security enforcing functions during acts of data mediation. It seeks to prevent tampering with data content and the security label and may bind the security label with the data content, and a range of other security functions.

SEL 104 allows applications 102 to be added or “plugged into” system 100, with the same security rules defined in rules engine 106 to apply to new applications 102.

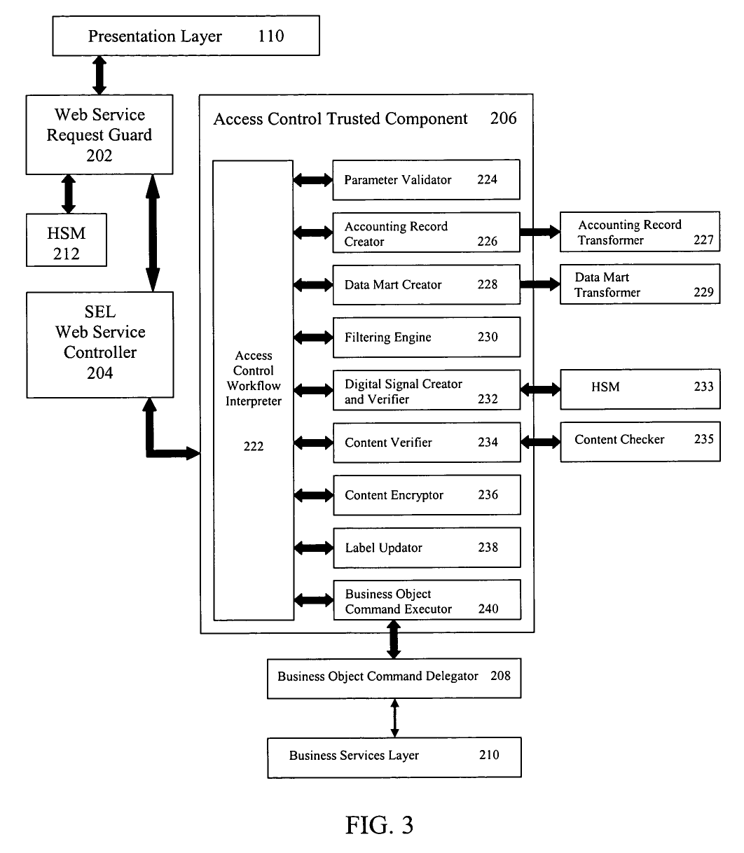

FIG. 3 illustrates a particular embodiment of SEL 104 of FIG. 2. In this particular embodiment, SEL 104 includes web service request guard (WSRG) 202, SEL web service controller 204, access control trusted component (ACTC) 206 and business object command delegator 208. Some of these components could be omitted or other components added. In addition, more functions could be added, some of the recited function omitted, or various functions combined.

Web Service Request Guard (WSRG) 202 validates web service messages received from Presentation Layer 110. WSRG 202 validates the body section of a SOAP message to prevent any unsolicited information from being passed in SEL 104. In a particular embodiment, WSRG 202 uses the XML schema that is specified in the Web Service Description Language (WSDL) to check that the data conforms to the schema specification. WSRG 202 may extract the body section into an appropriate data transfer object so that this information can be passed into the next component, SEL WEB Service Controller 204. WSRG 202 may extract a list of attachments so that this information can be passed into the next component. WSRG 202 may validate the SAML assertion part of the header section of the SOAP message in order to prevent any unsolicited information from being passed into SEL 104. WSRG 202 may verify that the SAML assertion credentials are valid and that the SAML assertion signature has not been changed. In a particular embodiment, a pre-certified hardware security module (HSM) 212 may assist in these verification operations. Once the SAML assertion is verified, WSRG 202 may extract the SAML assertion so that this information can be passed into the next component. WSRG 202 may log any failure to validate a request via the audit system, and the request can be blocked from further passage beyond WSRG 202.

In a particular embodiment, WSRG 202 may use a SAML assertion cache to improve performance. WSRG 202 will determine whether the SAML assertion has been previously verified, and if it has, WSRG 202 may avoid re-executing the verification process. Entries in the SAML cache may include the user business role, the SAML time limits, and a hash of the SAML assertions. If the SAML assertion is still valid time-wise and the hash of the SAML assertion is the same as the stored cached value, then the WSRG 202 does not need to proceed with the verification process. If the hash is different, then the assertion changed. The assertion may change because the time limit has expired and a new assertion has issued or because the user has changed business roles and the user credential set has changed. When the hash changes, the signature is verified and the entry replaced with the updated information. If the cache does not include an entry for a SAML assertion, WSRG 202 proceeds with the verification process, and if it verifies the SAML assertion, WSRG 202 adds an associated entry to the cache. WSRG 202 may include an independent scheduled process that maintains the state of the cache and removes any entries that are beyond their expired time.

SEL web service controller 204 may connect one or more web services presented by Presentation Layer 110 to at least one security enforcement workflow defined within ACTC 206. Each security enforcement workflow can be considered to be a Policy Enforcement Point (PEP) that applies to the given web service. SEL web service controller 204 may create the final service response. SEL web service controller 204 also handles errors that may occur during the access control workflow.

For example, web service controller 204 may perform the following operations when ingesting a new document into system 100. Web service controller 204 first may create an audit record of the attempt to ingest the document. Web service controller 204 may perform a policy check to verify that the user attempting the operation is permitted to perform it and that the partial metadata label is valid. Web service controller 204 may check the document for malicious code. If the content is clean, web service controller 204 may create a signature and store the signature in the metadata. Web service controller 204 may store the content in a document manager, which may return a unique reference to be added to the metadata. Web service controller 204 may perform a final policy check to ensure that all the necessary metadata attributes are populated before the metadata is signed and stored in the metadata store. If the metadata label is invalid or the content contains malicious code, web service controller 204 may abandon the ingestion process. Where any step in the security enforcement process fails due to an internal error, web service controller 204 may store the operation in a queue to be attempted later. If the retry succeeds, web service controller 204 may perform the next step; otherwise, the exception may cause the operation be put back on the queue. Web service controller 204 may advise system administrators of the error so that they can correct the cause of the failure. In a particular embodiment, system administrators may log accounting records to identify errors.

ACTC 206 may provide the functions that form the security enforcement workflows. ACTC 206 may determine access control using the XACML policies. ACTC 206 may also bind an object with its security attributes by XML signatures that use cryptographic methods. The binding may prevent tampering with the data stored within the business services layer 210. ACTC 206 may also ensure that any item to be displayed has a valid binding. ACTC 206 may validate parameters to prevent unsolicited information from being passed into system 100. ACTC 206 may create accounting records to capture what a user was attempting to do and what he was attempting to achieve. ACTC 206 may perform additional security functions, such as checking that any new content to be stored in business services layer 210 is free from any viruses and does not contain any mobile code such as macros and JavaScript. ACTC 206 may also be able to encrypt high classification documents so that they are not stored in the business services layer 210 in clear text. Encryption may prevent system administrators from being able to read high classification documents.

ACTC 206 may use three configuration files. One configuration file describes the security enforcement workflows. Another configuration file describes the business commands, or data management function provided by business services layer 210. A third configuration file describes the XACML policies. Each of these configuration files may be signed so that ACTC 206 may detect any tampering. SEL 104 may be disabled if ACTC 206 detects any tampering. An ACTC administrative tool may used to update the configuration files.

In the particular embodiment illustrated in FIG. 3, ACTC 206 includes various sub-modules that perform a number of distinct tasks. Access control workflow interpreter 222 may determine which other sub-modules are called and in the appropriate sequence. Access control workflow interpreter 222 may use the security enforcement workflow configuration file to maintain workflow information. The workflow configuration file may define workflows using Web Service Description Language (WSDL) to describe the request and response objects (messages) and top-level operations. The sub-modules of the ACTC 206 may have a corresponding WSDL defining the low-level operations and objects. The exact sequence of the low-level operations for a workflow may be defined by using Business Process Execution Language (BPEL).

Parameter validator 224 may include a library of parameter validation routines that are used to validate input parameters for type and content. In a particular embodiment, system administrators may configure the routines to predefine the exact form and set of characters that may be used.

Accounting record creator 226 may prepare an accounting record object for a request. The accounting record object may include information about a user or information about a service. After accounting record creator 226 prepares an object, accounting record creator 226 may convert the object into XML and pass the object to accounting record transformer 227. Accounting record transformer 227 may convert the incoming XML to the XML format that is used for the audit system. In this particular embodiment, accounting record transformer 227 acts as a mediator between accounting record creator 226 and the particular scheme used by the accounting record scheme.

Data mart creator 228 performs a similar function as accounting record creator 226, except the format of the record object may be different and the destination of the record may be different. Likewise, data mart transformer 229 performs similar functions as accounting record transformer 227, except that the transformation of the XML may be different and the destination of the record may be different.

Filtering engine 230 may evaluate the rules received from rules engine 106. Access control workflow interpreter 222 may indicate which policy is to be evaluated and may provide the subject, resource, and action attributes. As a result of the evaluation of the security policy, filtering engine 230 may provide a Boolean value indicating whether the evaluation was successful. In a particular embodiment, when an evaluation is unsuccessful, filtering engine 230 may provide a reason why the evaluation was unsuccessful.

Digital signature creator and verifier 232 interfaces with the hardware security module (HSM) 233, where the signature creation and verification take place. Digital signature creator and verifier 232 sends HSM 233 either a file or a completed metadata label to be signed or verified.

Content verifier 234 may check the content of each object to ensure that it does not contain any malicious code or virus. This checking is typically performed during the ingestion or publication of any object. Content verifier 234 sends the workflow's attached file(s) to content checker 235. If content checker 235 detects a virus or other malicious code, content verifier 234 may remove the infected attachment from system 100.

Content encryptor 236 may encrypts files with a set of certificates so that the people who are to decrypt them can do so.

Label updater 238 allows an object's security attributes to be updated with values from an appropriate business function.

Business object command executor 240 may allow access control workflow interpreter 222 to communicate with business services layer 210 and execute a given business object command. A business object command may be defined within the WSDL of the business services layer 210. The set of commands is held as one of the configurable files that has to be defined and signed before ACTC 206 can be used.

Business object command delegator 208 may serve as a mediator between ACTC 206 and business services layer 210. Business object command delegator 208 converts business object commands to particular web service messages and sends them to business services layer 210. Business object command delegator 208 may insert the SAML assertion into the web service header and the appropriate parameters into the body of the web service message. When a reply is received from business services layer 210, business object command delegator 208 may translate the results information back into the appropriate objects for ACTC 206. Business object command delegator 208 may also receive exceptions from business services layer 210 and take appropriate action according to the particular exception. Typically, business object command delegator 208 will pass the exception to ACTC 206, where access control workflow interpreter 222 will log the problem before sending it to SEL web service controller 204.

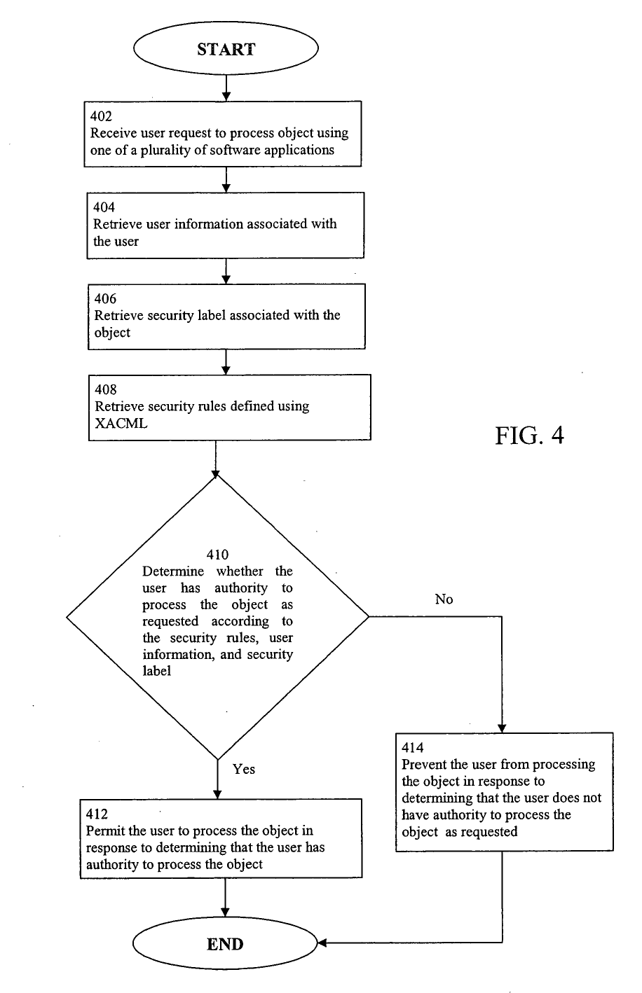

FIG. 4 illustrates a flowchart of a particular embodiment of a method of securing information accessible using a plurality of software applications. The method begins at step 402, where SEL 104 receives a user request to process a document or other object using one of software applications 102. At step 404, SEL 104 retrieves user attributes or information associated with the user. In a particular embodiment, SEL 104 receives the user information from directory service 108. At step 406, SEL 104 retrieves a security label associated with the object, and at step 408, SEL 104 retrieves security rules defined using XACML. At step 410, SEL 104 determines whether the user has authority to process the object as requested according to the security rules, user information, and security label. If the user has authority to process the object, SEL 104 permits the user to process the object at step 412, and if the user does not possess authority to process the object, SEL 104 prevents the user from processing the object at step 414. The method ends at step 416.

Although embodiments of the invention and advantages are described in detail, a person skilled in the art could make various alterations, additions, and omissions without departing from the spirit and scope of the present invention as defined by the appended claims.

To aid the patent office, and any readers of any patent issued on this application in interpreting the claims appended hereto, applicants wish to note that they do not intend any of the appended claims to invoke paragraph 6 of 35 U.S.C. § 112 as it exists on the date of filing hereof unless “means for” or “step for” are used in the particular claim.

What is claimed is:

1. A system for securing information accessible using a plurality of software applications, comprising:
a computer readable storage medium; and
computer software stored on the computer readable storage medium and operable to:
receive a request from a user to process information using one of a plurality of software applications;
retrieve user information associated with the user;
determine whether the user has authority to process the information as requested according to the retrieved user information and one or more rules defined using XACML;
allow the user to process the information using the software application in response to determining that the user has authority to process the information as requested; and
prevent the user from processing the information using the software application in response to determining that the user does not have authority to process the information as requested.

2. The system of claim 1, wherein at least some of the software applications are commercial off-the-shelf (COTS) applications.

3. The system of claim 1, wherein the computer software is further operable to receive the requests through a web-based interface.

4. The system of claim 1, wherein the request is to access the information.

5. The system of claim 1, wherein the computer software is further operable to:
receive from a first user a request to store a file using one of the plurality of software applications;
receive from the first user security information relating to the file;
associate the security information with the file;
receive from a second user a request to access the file using one of the plurality of software applications;
retrieve second user information associated with the second user;
retrieve the security information associated with the file;
determine whether the second user has authority to access the file according to the second user information, the security information, and one or more rules defined using XACML;
allow the second user to access the file using the software application in response to determining that the second user has authority to access the file; and
prevent the second user from accessing the file using the software application in response to determining that the second user does not have authority to access the file.

6. The system of claim 1, wherein the computer software further comprises application wrappers operable to interface with the plurality of software applications using the applications' application programming interfaces (APIs).

7. The system of claim 1, wherein the computer software is further operable to receive a file for storage and to generate a security label to be associated with the file.

8. The system of claim 1, wherein the rules defined using XACML establish how the computer software may compare the received user information to one or more attributes from a security label associated with the information to determine whether the user has authority to process the information as requested

9. The system of claim 1, wherein at least one of the rules provides that a confidentiality level of the user must meet or exceed a confidentiality level associated with the information.

10. The system of claim 1, wherein the rules may be changed to implement new security requirements without changing the computer software.

11. A method for securing information accessible using a plurality of software applications, comprising:
receiving a request from a user to process information using one of a plurality of software applications;
retrieving user information associated with the user;
determining whether the user has authority to process the information as requested according to the retrieved user information and one or more rules defined using XACML;
allowing the user to process the information using the software application in response to determining that the user has authority to process the information as requested; and
preventing the user from processing the information using the software application in response to determining that the user does not have authority to process the information as requested.

12. The method of claim 11, wherein at least some of the software applications are commercial off-the-shelf (COTS) applications.

13. The method of claim 11, further comprising receiving requests from users to process information through a web-based interface.

14. The method of claim 11, wherein the request is to access the information.

15. The method of claim 11, wherein the request is to search the information.

16. The method of claim 11, further comprising:
receiving from a first user a request to store a file using one of the plurality of software applications;
receiving from the first user security information relating to the file;
associating the security information with the file;
receiving from a second user a request to access the file using one of the plurality of software applications;
retrieving second user information associated with the second user;
retrieving the security information associated with the file;
determining whether the second user has authority to access the file according to the second user information, the security information, and one or more rules defined using XACML;
allowing the second user to access the file using the software application in response to determining that the second user has authority to access the file; and
preventing the second user from accessing the file using the software application in response to determining that the second user does not have authority to access the file.

17. The method of claim 11, further comprising interfacing with the plurality of software applications using the applications' application programming interfaces (APIs).

18. The method of claim 11, further comprising:
receiving a file for storage; and
generating a security label to be associated with the file.

19. The method of claim 11, wherein the rules defined using XACML establish how to compare the received user information to one or more attributes from a security label associated with the information to determine whether the user has authority to process the information as requested

20. The method of claim 11, wherein at least one of the rules provides that a confidentiality level of the user must meet or exceed a confidentiality level associated with the information.
